(19) United States
(12) Patent Application Publication
(10) Pub. No.: US 2005/0134125 A1
(43) Pub. Date: Jun. 23, 2005

(54) Cooling device for built-in-spindle type spindle motor of machine tool

(75) Inventor: In Chan Kim, Pusan (KR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: DAEWOO HEAVY INDUSTRIES & MACHINERY LTD., Incheon (KR)

(21) Appl. No.: 11/008,657

(22) Filed: Dec. 10, 2004

(30) Foreign Application Priority Data
Dec. 19, 2003 (KR) 2003-94137

(51) Int. Cl. H02K 9/00; H02K 7/00

(52) U.S. Cl. 310/58; 310/55

(57) ABSTRACT

A cooling device for cooling a built-in-spindle type spindle motor of a machine tool, in which the spindle motor includes a motor housing enclosing a spindle, a rotor fixed around the spindle, and a stator secured to the inner circumferential surface of the motor housing to surround the rotor with a clearance being formed between the rotor and the stator, wherein the cooling device comprises: a cooling gas supply source for supplying cooling gas; a motor housing with a cooling gas introduction passage for introducing and guiding the cooling gas supplied from the cooling gas supply source to one side of the rotor and the stator; and a cooling gas injection nozzle removably installed in the motor housing and having one or more nozzle openings oriented to inject the cooling gas to the clearance between the rotor and the stator.

### BACKGROUND OF THE INVENTION

1. Field of the Invention

The present invention relates to a cooling device for a spindle motor for driving a spindle of a machine tool, and in particular to a cooling device for a built-in-spindle type spindle motor of a machine tool, which can efficiently cool a spindle motor.

2. Description of the Related Art

A machine tool such as a numerical control lathe, a machining center, or the like has a spindle motor for rotating a spindle. Such a spindle motor is trending toward a built-in type, in which a spindle motor is integrated with a spindle. A built-in type spindle motor rapidly rotates a spindle without noise and vibration.

Such a built-in type spindle motor comprises a motor housing 10 as shown in FIG. 1. The motor housing 10 is configured to enclose a spindle S. Here, respective bearings 12 are interposed between the motor housing 10 and the spindle S to assist the rotation of the spindle S. In addition, the opposite open sides of the motor housing 10 are sealed by covers 14.

The spindle motor comprises a rotor 20 fixed around the spindle S and a stator 22 located to surround the rotor 20 with a clearance t being formed between the rotor 20 and the stator 22. The stator 22 is secured to the inner circumferential surface of the motor housing 10.

The spindle motor is provided with a cooling device for cooling high temperature generated while the spindle motor is being operated. The cooling device is a fluid-type cooling device using fluid such as water or oil, wherein the cooling device comprises a spiral flow passage 30 and fluid supply means for supplying fluid such as water or oil to the spiral flow passage 30. In particular, the fluid supply means consists of a fluid pump 32.

Such a fluid-type cooling device is configured to pump fluid with the fluid pump 32 and then supply the pumped fluid to the spiral flow passage 30, thereby allowing the fluid passing through the spiral flow passage 30 to cool the motor housing 10.

However, such a conventional fluid-type device has a disadvantage in that it can only cool the heat transferred to the motor housing 10 because it employs a construction that supplies cooling fluid to the motor housing 10.

Such a disadvantage makes it difficult to cool the rotor 20 and the stator 22, thereby generating heat of high temperature, which gives rise to a problem that the heat emitted from the rotor 20 and the stator 22 is transferred to the spindle S.

Meanwhile, the heat transferred to the spindle S causes fine deformation of the spindle, e.g., bending deformation, as a result of which a problem arises that the spindle cannot rotate with high precision, thereby making it impossible for a tool mounted on the spindle S to machine a work-piece with high precision. Consequently, due to the heat transferred to the spindle, poor work-pieces with inferior precision may be mass-produced.

Taking this into account, a cooling device for preventing the fine deformation of a spindle has been recently proposed. As an example, Japanese Patent Laid-open Publication No. 7-185994 discloses a cooling device comprising an air supply path capable of supplying air to a motor housing and a nozzle provide at an end of the air supply path to inject the supplied air to a spindle. The cooling device renders air to be introduced into the air supply path and then injects the introduced air directly to the spindle using the nozzle to cool the spindle.

Such a cooling device has an advantage of directly cooling the spindle, thus preventing the deformation of the spindle. However, because the cooling device also employs a construction that cannot cool the rotor and the stator, from which heat is generated intensively, it is impossible for the cooling device to basically prevent the generation of high temperature, as a result of which the heat generated from the rotor and the stator is continuously transferred to the spindle, whereby there is a problem in that the cooling efficiency is deteriorated.

### SUMMARY OF THE INVENTION

Accordingly, the present invention has been made to solve the above-mentioned problems occurring in the prior art, and an object of the present invention is to provide a cooling device for cooling a built-in-spindle type spindle motor of a machine tool, which can effectively cool a rotor and a stator, from which high temperature is generated, thereby basically blocking the heat transfer to the spindle.

Another object of the present invention is to provide a cooling device for cooling a built-in-spindle type spindle motor of a machine tool, which can basically block the heat transfer to the spindle, thereby allowing the spindle to rotate with high precision and thus making it possible to produce a work-piece with high precision.

In order to achieve the above-mentioned objects, there is provided a cooling device for cooling a built-in-spindle type spindle motor of a machine tool, in which the spindle motor includes a motor housing enclosing a spindle, a rotor fixed around the spindle, and a stator secured to the inner circumferential surface of the motor housing to surround the rotor with a clearance being formed between the rotor and the stator, wherein the cooling device comprises: cooling gas supply means for supplying cooling gas; a motor housing with a cooling gas introduction passage for introducing and guiding the cooling gas supplied from the cooling gas supply means to a side of the rotor and the stator; and a cooling gas injection nozzle removably installed in the motor housing and having one or more nozzle openings oriented to inject the cooling gas to the clearance between the rotor and the stator.

Preferably, the cooling gas injection nozzle has a ring type body fixedly mounted on the inner circumferential surface of the motor housing to be arranged along the periphery of one side of the rotor and the stator, and wherein the ring type body comprises a flow channel formed in an annular shape along the bottom side of the ring type body to communicate with the cooling gas introduction passage, and a plurality of nozzle openings for injecting the cooling gas flowing along the flow channel toward the tip between clearance the rotor and the stator.

### BRIEF DESCRIPTION OF THE DRAWINGS

The above and other objects, features and advantages of the present invention will be more apparent from the following detailed description taken in conjunction with the accompanying drawings, in which:

FIG. 1 is a side cross-sectional view showing the construction of a conventional built-in-spindle type spindle motor of a machine tool;

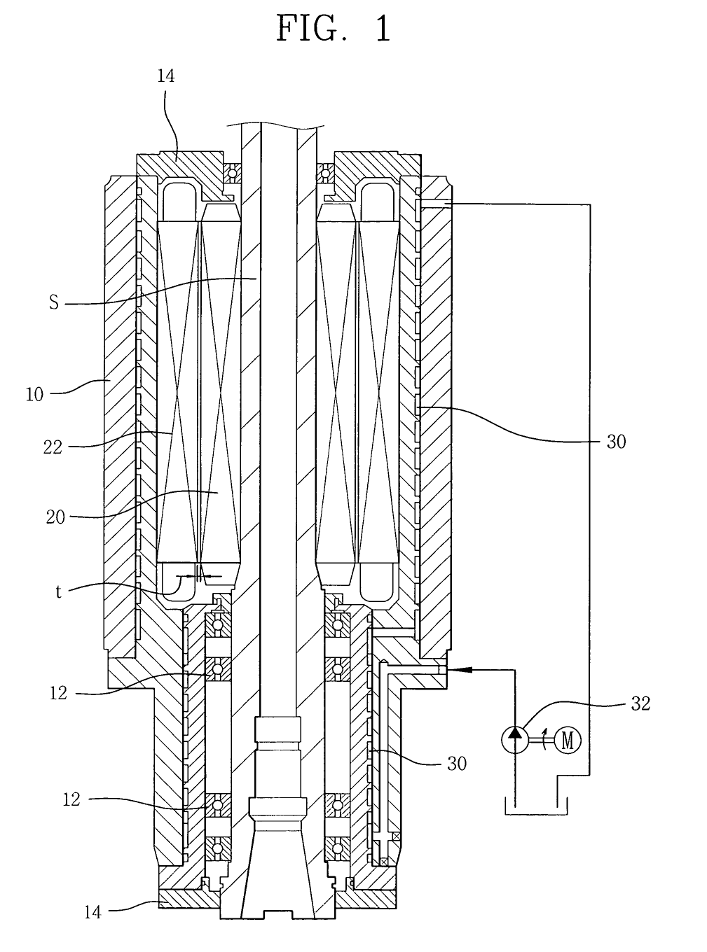

FIG. 2 is a side cross-sectional view showing the a construction of the inventive cooling device of a built-in-spindle type spindle motor;

FIG. 3. is an exploded perspective view showing the construction of a cooling gas introduction passage and a cooling gas injection nozzle that forms the inventive spindle motor cooling device in detail; and

FIG. 4 is a schematic view showing a variant of the cooling gas injection nozzle that forms the inventive spindle motor cooling device.

### DETAILED DESCRIPTION OF THE PREFERRED EMBODIMENTS

Hereinafter, preferred embodiments for a cooling device for a built-in-spindle type spindle motor according to the present invention will be described with reference to the accompanying drawings. Components same with the conventional ones described above will be respectively indicated by the same reference numerals used in describing the prior art.

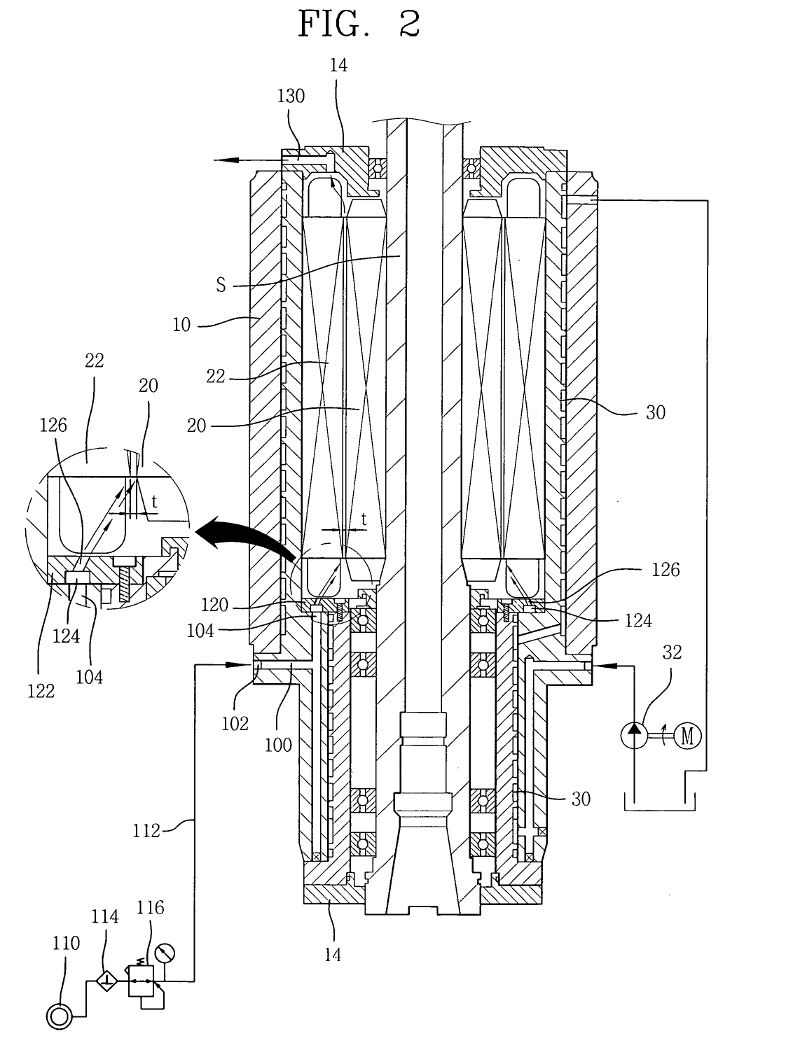

Before describing the inventive spindle motor cooling device, a construction of a spindle motor is briefly described at first with reference to FIG. 2. As shown in the figure, the spindle motor includes a motor housing 10. The motor housing 10 is configured to enclose a spindle S. The opposite ends of the motor housing 10 are sealed by covers 14.

In addition, the spindle motor comprises a rotor 20 fixed around the rotor 20 and a stator 22 located around the rotor 20 with a clearance being formed between the rotor and the stator. The stator 22 is secured to the inner circumferential surface of the motor housing 10.

The spindle motor further comprises a cooling device for cooling the motor housing 10. The cooling device comprises a spiral flow passage 30 formed along the periphery of the motor housing 10, and a fluid pump 32 for supplying fluid such as water or oil to the spiral flow passage 30.

Such a fluid-type cooling device pumps fluid with the fluid pump 32 and then supplies the pumped fluid to the spiral flow passage 30, so that the fluid cools the motor housing 10 while passing through the spiral flow passage 30.

Next, the inventive cooling device for cooling the rotor 20 and the stator 22 is described. At first, the inventive cooling device comprises a cooling gas introduction passage 100 formed in the motor housing 10 as shown in FIG. 2.

The cooling gas introduction passage 100 has an inlet 102 and an outlet 104. The inlet 102 is formed toward the outside of the motor housing 10 and arranged to introduce cooling gas, e.g., cooling air, cooling gas or the like. In addition, the outlet 104 is formed toward the interior of the motor housing 10 and arranged to discharge the introduced cooling gas into the interior of the motor housing 10.

Referring again to FIG. 2, the inventive cooling device comprises cooling gas supply means for supplying cooling gas to the cooling gas introduction passage 100. The cooling gas supply means consists of a pneumatic pressure source 110, e.g., a pneumatic pump.

Such a pneumatic pump 110 pumps cooling air and renders the pumped cooling air to be introduced into the cooling gas introduction passage 100. Here, the pneumatic pressure source 110 is connected with the cooling gas introduction passage 100 of the motor housing 10 through a pneumatic line 112, in which the pneumatic line 112 is sequentially provided with a filter 114 for filtering the cooling air and a pressure control valve 116 for controlling the pressure of the cooling air.

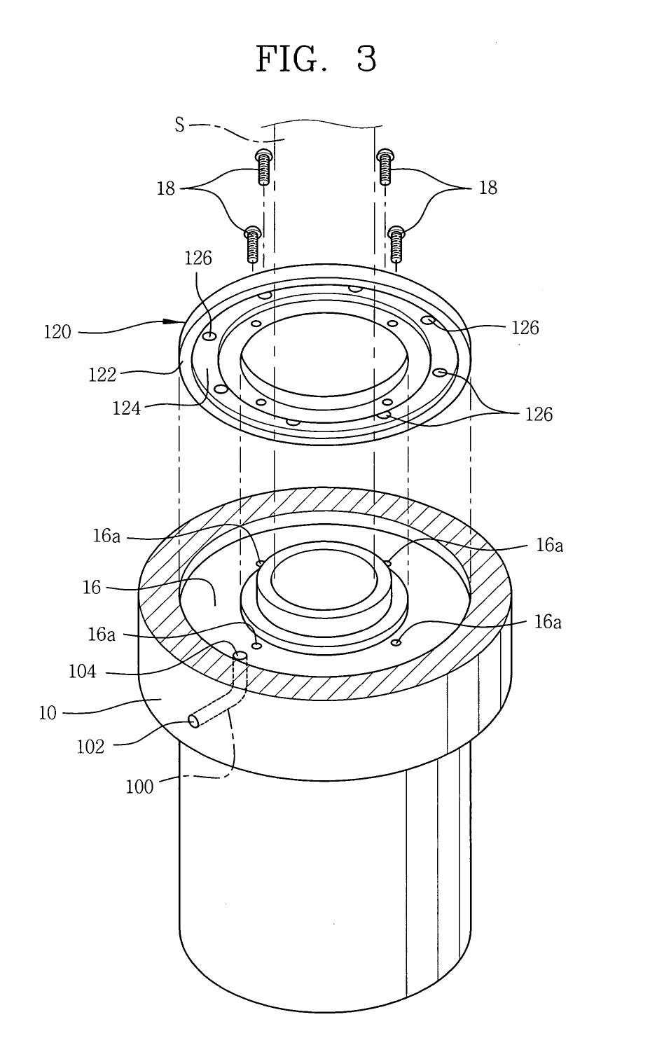

Referring to FIGS. 2 and 3, the inventive cooling device comprises a cooling gas injection nozzle 120 to inject the cooling air discharged from the outlet of the cooling gas introduction passage 100 to the rotor 20 and the stator 22.

The cooling gas injection nozzle 120 has a ring type body 122. The ring type body 122 is located around the spindle S and removably mounted on the inner circumferential surface of the motor housing 10. Here, the inner circumferential surface of the motor housing 10 is formed with an annular seating part 16 so that the ring type body 122 can be stably seated on the seating part 16, and a plurality of screw holes 16 are formed in the seating part 16. Screws 18 are threaded into the screw holes 16 through the ring type body 122. As the screws 18 are threaded into the screw holes 16 through the screw holes 16a in this manner, the ring type body 122 is removably installed in the motor housing 10.

The bottom side of the ring type body 122 is formed with a flow channel 124 communicated with the outlet 104 of the cooling introduction passage 100. The flow channel 124 is formed in an annular shape along the bottom side of the ring type body 122. Such a flow channel 124 serves to guide the cooling air discharged from the cooling gas introduction passage 100 along the inner circumferential surface of the motor housing 10.

In addition, a plurality of nozzle openings 126 are formed on the top side of the ring type body 122 to inject the cooling air in the flow channel 124 toward the rotor 20 and the stator 22. The nozzle openings 126 are equally spaced along the ring type body 122.

These nozzle openings 126 serve to directly cool the rotor 20 and the stator 22 both generating high temperature by injecting the cooling air in the flow channel 124 toward the rotor 20 and the stator 22. In particular, the nozzle openings 126 serve to basically block the generation of high temperature by directly cooling the rotor 20 and the stator 22 both generating high temperature. Furthermore, as the nozzle openings 126 evenly inject the cooling air while following along the periphery of the bottom side of the rotor 20 and stator 22 under the rotor 20 and stator 22, the entire of the rotor 20 and the stator 22 are more efficiently cooled.

Meanwhile, the nozzle openings 126 of the ring type body 122 are arranged to face the rotor 20 and the stator 22, in particular the intermediate position between the rotor 20 and the stator 22. This is to inject the cooling air to the clearance t between the rotor 22 and the stator 22 because the high temperature is mainly generated from the area where the rotor 20 and the stator 22 come into contact with each other. Accordingly, by injecting the cooling air to the clearance t between the rotor 20 and the stator 22, it is possible to efficiently cool the high temperature generating area.

The cooling air injected toward the clearance t between the rotor 20 and the stator 22 moves along the clearance t and fully cools the rotor 20 and the stator 22. In addition, the cooling air is discharged to the opposite side to the rotor 20 and the stator 22 after cooling the rotor 20 and the stator 22.

Returning again to FIG. 2, the inventive cooling device comprises a vent passage for venting the cooling air, which has been discharged to the opposite side to the rotor 20 and the stator 22, out of the motor housing I O. The vent passage 130 is formed on a cover 14 of the motor housing 10. Such a vent passage 130 serves to quickly discharge outwardly the cooling air discharged from between the rotor 20 and the stator 22. Meanwhile, although the vent passage 130 is shown as being formed in the cover 14 of the motor housing 10, it is possible to form such a vent passage, e.g., directly on the motor housing 10.

Next, a working example of the present invention is described with reference to FIG. 2. At first, cooling air is pumped from the pneumatic pressure source 110. Then, the pumped cooling air is introduced into the cooling gas introduction passage 100 of the motor housing 10 by way of the pneumatic pressure line 112. At this time, the cooling air is filtered and controlled to have an appropriate pressure while passing through the filter 114 and the pressure control valve 116.

In addition, the cooling air introduced into the cooling gas introduction 100 flows to the outlet 104 and then flows into the flow channel 124, and the cooling air flowing into the flow channel 124 moves along the flow channel 124. Then, the cooling air moving along the flow channel 124 is injected around the bottom sides of the rotor 20 and the stator 22 through the nozzle openings 126. In particular, the cooling air is injected to the clearance t between the rotor 20 and the stator 22.

Meanwhile, the cooling air injected to the clearance t between the rotor 20 and the stator 22 absorbs the high temperature generated from the rotor 20 and the stator 22 while rapidly moving along the clearance t between the rotor 20 and the stator 22, thereby fully cooling the rotor 20 and the stator 22. Then, the cooling air is discharged to the opposite side of the rotor 20 and the stator 22 after cooling the rotor 20 and the discharged cooling air is outwardly vented through the vent passage 130 of the cover 14.

According to such working of the present invention, the cooling air is directly injected to the rotor 20 and the stator 22, thereby making it possible to directly cool the rotor 20 and the stator 22 which are the source of high temperature. In particular, by blowing the cooling air into the clearance t between the rotor 20 and the stator 22 which are the main source of high temperature, it is possible to basically block the generation of high temperature.

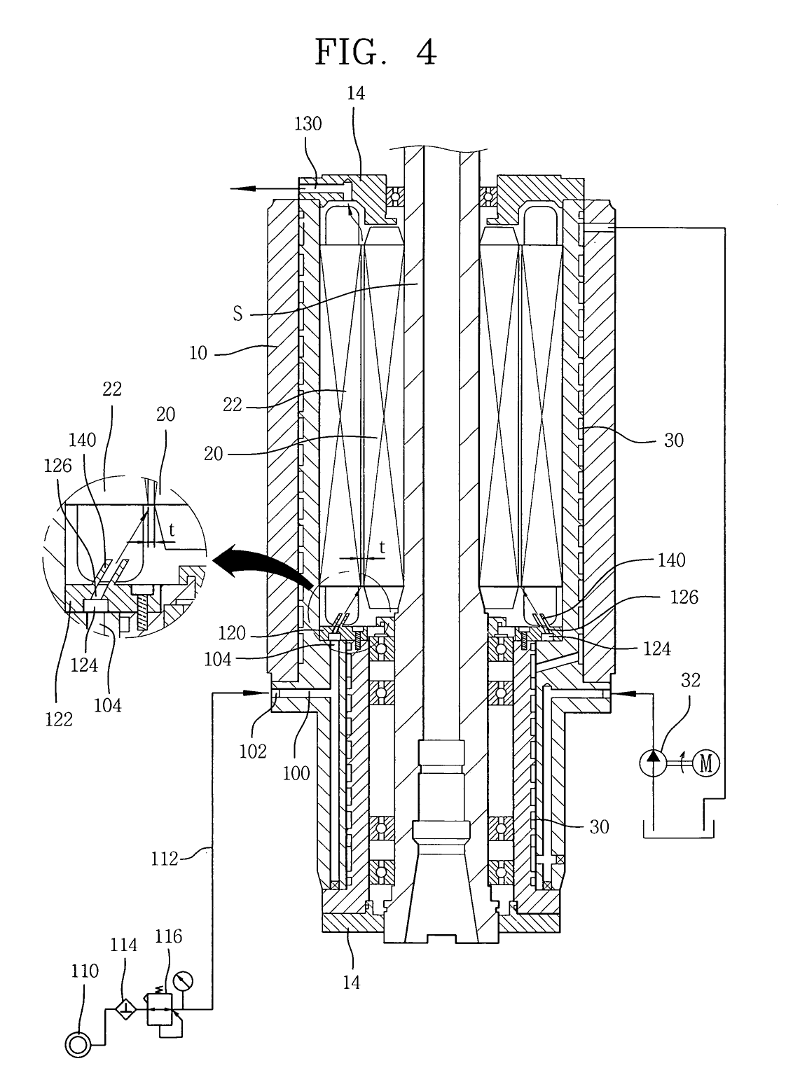

FIG. 4 shows a variant of the inventive cooling gas injection nozzle 140. The cooling gas injection nozzle 120 of the variant further comprises a plurality of guiders 140 for directly guiding the cooling air injected from the nozzle openings 126 to the clearance t between the rotor 20 and the stator 22.

The guiders 140 are guide tubes integrally formed with the ring type body 122 and extending toward the clearance t between the rotor 20 and the stator 22 so as to guide the cooling air injected from the nozzle openings 126 to the clearance t between the rotor 20 and the stator 22 so that more cooling air can be flown into the clearance t between the rotor 20 and the stator 22, thereby maximizing the cooling effect.

As described above, according to the inventive spindle motor cooling device, as cooling air of high pressure is directly injected to a rotor and a stator, it is possible to directly cool the rotor and the stator which are the source of generating high temperature. In particular, by blowing cooling air into a clearance between the rotor and the stator which are the main source of generating high temperature, it is possible to basically block the generation of high temperature, thereby maximizing the cooling effect.

While the invention has been shown and described with reference to certain preferred embodiments thereof for the purpose of exemplification, the present invention is not limited to the specific embodiment. It will be understood by those skilled in the art that various changes in form and details may be made therein without departing from the spirit and scope of the invention as defined by the appended claims.

1. A cooling device for cooling a built-in-spindle type spindle motor of a machine tool, in which the spindle motor includes a motor housing enclosing a spindle, a rotor fixed around the spindle, and a stator secured to the inner circumferential surface of the motor housing to surround the rotor with a clearance being formed between the rotor and the stator, the cooling device comprises:
cooling gas supply means for supplying cooling gas;
a motor housing with a cooling gas introduction passage for introducing and guiding the cooling gas supplied from the cooling gas supply means to a side of the rotor and the stator; and
a cooling gas injection nozzle removably installed in the motor housing and having one or more nozzle openings so oriented as to inject the cooling gas to the clearance between the rotor and the stator.

2. A cooling device as claimed in claim 1, wherein the cooling gas injection nozzle has a ring type body fixedly mounted on the inner circumferential surface of the motor housing to be arranged along the periphery of one side of the rotor and the stator, and
wherein the ring type body comprises a flow channel formed in an annular shape along the bottom side of the ring type body to communicate with the cooling gas introduction passage, and a plurality of nozzle openings for injecting the cooling gas flowing along the flow channel toward the tip between clearance the rotor and the stator.

3. A cooling device as claimed in claim 1, further comprising a plurality of guiders for guiding the cooling gas injected from the nozzle openings of the cooling gas injection nozzle directly to the clearance of the rotor and the stator, and
wherein the guiders are guide tubes extending from the peripheries of the nozzle openings, respectively, toward the clearance between the rotor and stator.

4. A cooling device as claimed in claim 2, further comprising a plurality of guiders for guiding the cooling gas injected from the nozzle openings of the cooling gas injection nozzle directly to the clearance of the rotor and the stator, and
wherein the guiders are guide tubes extending from the peripheries of the nozzle openings, respectively, toward the clearance between the rotor and stator.

5. A cooling device as claimed in claim 1, further comprising a vent passage formed in the motor housing so as to outwardly discharge the cooling air passing through the clearance between the rotor and the stator.

6. A cooling device as claimed in claim 1, further comprising a vent passage formed in the motor housing so as to outwardly discharge the cooling air passing through the clearance between the rotor and the stator.
